(19) United States
(12) Patent Application Publication
(10) Pub. No.: US 2021/0122873 A1
(43) Pub. Date: Apr. 29, 2021

(54) AQUEOUS POLYURETHANE DISPERSIONS

(71) Applicant: COVESTRO LLC, Pittsburgh, PA (US)

(72) Inventor: Makoto NAKAO, Pittsburgh, PA (US)

(21) Appl. No.: 16/666,835

(22) Filed: Oct. 29, 2019

(51) Int. Cl. C08G 18/42; C08G 18/02; C08K 5/17

(52) U.S. Cl. CPC C08G 18/4216; C08K 5/17; C08G 18/025

(57) ABSTRACT

The present invention provides an aqueous polyurethane dispersion (PUD) which comprises (1) a polyester polyurethane dispersion which is free of solubilizing agents having carboxyl functionality and (2) a polycarbodiimide dispersion. These dispersions have stabilized performance properties. In addition, the polycarbodiimide dispersion has been found to restore the physical performance of an aqueous polyester polyurethane dispersion in which the performance has degraded due to the polyester component.

### FIELD OF THE INVENTION

The present invention relates to an aqueous polyurethane dispersion (PUD) which comprises a polyester based polyurethane dispersion which is free of solubilizing agents having carboxyl functionality, and a polycarbodiimide dispersion. The invention relates to these PUD compositions which are stabilized against degradations and also to restored physical performance of these PUD compositions after degradation of performance.

### BACKGROUND OF THE INVENTION

One component polyurethane dispersions are desirable as they are typically easy to handle and easy to apply. In general, the performance of one component polyurethane dispersions is lower than the performance of convention two component urethane coatings, particularly with regard to water and/or solvent resistance. Polyester based polyurethane dispersions are known to have poor hydrolysis resistance and this contributes to decreased performance over time. Thus, there is a need to stabilize polyester based PUDs against hydrolysis. The addition of polycarbodiimide to a PUD which contains carboxylic acid functionality improves the performance of the PUD and stabilizes the PUD against hydrolysis, however, the mixture of PUD and polycarbodiimide still has limited pot-life. Thus, there is a need and desire in the industry for a stable one component (1K) coating system that combines the ease of handling and applying of one component (1K) waterborne systems (i.e. polyester based PUDs) with the high performance properties such as chemical resistance.

### SUMMARY OF THE INVENTION

Accordingly, the present invention is directed to one component (1K) coating systems based on a polyester based PUDs containing a solubilizing component that is free of carboxylic acid groups that are storage stabile and can be handled easily as conventional PUDs but form crosslinked, highly durable coatings with a polycarbodiimide dispersion and also restores the physical performance of an aqueous PUD after degradation of performance.

The present invention provides an aqueous polyurethane dispersion (PUD) that comprises a polyester polyol that comprises a solubilizing component that is free of carboxylic acid groups, and a polycarbodiimide dispersion.

The present invention provides an aqueous polyurethane dispersion (PUD) comprising:
(1) an aqueous polyester based polyurethane dispersion comprising:
   (a) a polyester polyol component;
   (b) a di- or polyisocyanate component;
   (c) a chain extender containing at least two amine groups;
   (d) a solubilizing component that is free of carboxylic acid groups;
   (e) a surfactant;
   (f) water;
   and, optionally,
   (g) a catalyst;
      and
(2) from 1 to 20% by weight, based on 100% by weight of (1) the aqueous polyester based polyurethane dispersion, of a polycarbodiimide dispersion.

The invention also relates to a process for preparing an aqueous polyurethane dispersion (PUD) comprising
(A) reacting:
   (1) an aqueous polyester based polyurethane dispersion comprising:
      (a) a polyester polyol component;
      (b) a di- or polyisocyanate component;
      (c) a chain extender containing at least two amine groups;
      (d) a solubilizing component that is free of carboxylic acid groups;
      (e) a surfactant;
      (f) water;
      and, optionally,
      (g) a catalyst;
   and
   (2) 1 to 20% by weight, based on 100% by weight of (1) the aqueous polyester based polyurethane dispersion, of a polycarbodiimide dispersion.

The present invention provides a stable, one-component polyurethane dispersions (PUD) based on polyester based polyurethane dispersions in which the polyester polyols have a range of molecular weights. This chemistry provides coatings, adhesives, sealants, paints, primers, topcoats having excellent chemical resistance.

These and other advantages and benefits of the present invention will be apparent from the Detailed Description of the Invention herein below.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a).

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification. The various embodiments disclosed and described in this specification can comprise, consist of, or consist essentially of the features and characteristics as variously described herein.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

Although compositions and methods are described in terms of “comprising” various components or steps, the compositions and methods can also “consist essentially of” or “consist of” the various components or steps.

The present inventors have surprisingly found that coatings, adhesives, sealants, and paints produced from the inventive polyurethane dispersions have excellent chemical resistance properties. In addition, these dispersions provide coatings, adhesives, sealants, and paints.

As used herein, “polymer” encompasses prepolymers, oligomers and both homopolymers and copolymers; the prefix “poly” in this context referring to two or more. As used herein, “molecular weight”, when used in reference to a polymer, refers to the number average molecular weight (“Mₙ”), unless otherwise specified. As used herein, the Mₙ of a polymer containing functional groups, such as a polyol, can be calculated from the functional group number, such as hydroxyl number, which is determined by end-group analysis.

As used herein, the term “aliphatic” refers to organic compounds characterized by substituted or unsubstituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure thereof. Therefore, cycloaliphatic compounds are a subset of aliphatic compounds. Therefore, the term “aliphatic” encompasses aliphatic compounds and cycloaliphatic compounds.

As used herein, “diisocyanate” refers to a compound containing two isocyanate groups. As used herein, “polyisocyanate” refers to a compound containing two or more isocyanate groups. Hence, diisocyanates are a subset of polyisocyanates.

As used herein, the term “dispersion” refers to a composition comprising a discontinuous phase distributed throughout a continuous phase. For example, “waterborne dispersion” and “aqueous dispersion” both refer to compositions comprising particles or solutes distributed throughout liquid water. Waterborne dispersions and aqueous dispersions may also include one or more co-solvents in addition to the particles or solutes and water. As used herein, the term “dispersion” includes, for example, colloids, emulsions, suspensions, sols, solutions (i.e., molecular or ionic dispersions), and the like.

As used herein, the term “aqueous polyurethane dispersion” means a dispersion of polyurethane particles in a continuous phase comprising water. As used herein, the term “polyurethane” refers to any polymer or oligomer comprising urethane (i.e., carbamate) groups, urea groups, or both. Thus, the term “polyurethane” as used herein refers collectively to polyurethanes, polyureas, and polymers containing both urethane and urea groups, unless otherwise indicated.

In certain embodiments, the aqueous polyurethane dispersion (PUD) herein comprises (1) an aqueous polyester based polyurethane dispersion, and (2) from 1 to 20% by weight, based on 100% by weight of (1), of a polycarbodiimide dispersion.

In certain embodiments, the aqueous polyester based polyurethane dispersion comprises one or more polyester based polyurethanes that are the reaction product of reactants comprising, consisting essentially of, or, in some cases, consisting of: a polyester polyol; a di and/or polyisocyanate; a chain extender containing at least two amine groups; a solubilizing agent that is free of carboxylic acid groups; a surfactant, a catalyst, and water.

The present invention is directed to an aqueous polyurethane dispersion (PUD) comprising the reaction product of: (1) an aqueous polyester based polyurethane dispersion comprising (a) a polyester polyol; (b) a di- and/or polyisocyanate; (c) a chain extender containing at least two amine groups; (d) a solubilizing agent that is free of carboxylic acid groups; (e) a surfactant, (f) a catalyst, and (g) water; and (2) from 1 to 20% by weight, based on 100% by weight of (1) the aqueous polyester based polyurethane dispersion, of a polycarbodiimide dispersion.

Suitable polyester polyols (a) include those having a molecular weight Mₙ of from 400 to 8000 g/mol, such as 400 to 6000 g/mol or, in some cases, 500 to 3000 g/mol, 1000 to 3000 g/mol or 1500 to 3000 g/mol. In certain embodiments, these polyester polyols have a hydroxyl number of from 20 to 400 mg KOH/g of substance, such as 20 to 300 mg KOH/g of substance, 20 to 200 mg KOH/g of substance or 20 to 100 mg KOH/g of substance. In certain embodiments, these polyester polyols have a hydroxyl functionality of 1.5 to 6, such as 1.8 to 3 or 1.9 to 2.1. As will be appreciated, the Mₙ of a polyester polyol can, as discussed earlier, be calculated from the functional group number, such as hydroxyl number, which is determined by end-group analysis. “Hydroxyl number”, as used herein, is determined according to DIN 53240.

Suitable polyester polyols (a) herein are the polycondensation products of di- as well as optionally tri- and tetra-ols and di- as well as optionally tri- and tetra-carboxylic acids or hydroxycarboxylic acids or lactones. Instead of the free polycarboxylic acids it is also possible to use the corresponding polycarboxylic acid anhydrides or corresponding polycarboxylic acid esters of lower alcohols to prepare the polyesters. Examples of suitable diols are ethylene glycol, butylene glycol, diethylene glycol, triethylene glycol, polyalkylene glycols such as polyethylene glycol, further 1,2-propanediol, 1,3-propanediol, 1,3-butanediol, 1,4-butanediol, 1,6-hexanediol and isomers, 1,8-octanediol, neopentyl glycol, 1,4-bishydroxymethyl-cyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, lactone-modified diols, or hydroxypivalic acid neopentyl glycol ester. In order to achieve a functionality >2, polyols having a functionality of 3 can optionally be used proportionately, for example trimethylolpropane, glycerol, erythritol, pentaerythritol, trimethylolbenzene or trishydroxyethyl isocyanurate.

Suitable dicarboxylic acids are, for example, phthalic acid, isophthalic acid, terephthalic acid, tetrahydrophthalic acid, hexahydrophthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, and/or 2,2-dimethylsuccinic acid. Anhydrides of those acids can likewise be used, where they exist. Thus, for the purposes of the present invention, anhydrides are included in the expression “acid”. Monocarboxylic acids, such as benzoic acid and hexanecarboxylic acid, can also be used, provided that the mean functionality of the polyol is 2. Saturated aliphatic or aromatic acids can be used, such as adipic acid or isophthalic acid. Trimellitic acid is a polycarboxylic acid which can also optionally be used.

Hydroxycarboxylic acids which can be used as reactants in the preparation of a polyester polyol having terminal hydroxyl groups are, for example, hydroxycaproic acid, hydroxybutyric acid, hydroxydecanoic acid, hydroxystearic acid and the like. Suitable lactones are, for example, ε-caprolactone, butyrolactone and their homologues.

In certain embodiments of the present invention, the polyol comprises or, in some cases, consists essentially of or consists of a polyester diol that is a reaction product of butanediol and one or more of neopentyl glycol, hexanediol, ethylene glycol, and diethylene glycol with adipic acid and one or more of phthalic acid and isophthalic acid, such as polyester polyols that are a reaction product of at least one of butanediol, neopentyl glycol, and hexanediol with at least one of adipic acid and phthalic acid.

Suitable di and/or polyisocyanates (b) include, but are not limited to, aromatic, araliphatic, aliphatic and cycloaliphatic polyisocyanates, such as, for example, 1,4-butylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, 1,4-cyclohexylene diisocyanate, 1,4-phenylene diisocyanate, 2,4- and/or 2,6-toluene diisocyanate or hydrogenated 2,4- and/or 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), (S)-alkyl 2,6-diisocyanato-hexanoates or (L)-alkyl 2,6-diisocyanatohexanoates.

Polyisocyanates having a functionality >2 can also be used if desired. Such polyisocyanates include modified diisocyanates having a uretdione, isocyanurate, urethane, allophanate, biuret, iminooxadiazine-dione and/or oxadiazinetrione structure, as well as unmodified polyisocyanates having more than 2 NCO groups per molecule, for example 4-isocyanatomethyl-1,8-octane diisocyanate (nonane triisocyanate) or triphenylmethane-4,4′,4″-triisocyanate.

In some embodiments of the present invention, di- and/or polyisocyanates or polyisocyanate mixtures containing only aliphatically and/or cycloaliphatically bonded isocyanate groups are used that have a mean functionality of from 2 to 4, such as 2 to 2.6 or 2 to 2.4.

Suitable chain extenders (c) which contain at least two amine groups include compounds such as, for example, di- or poly-amines as well as hydrazides, for example ethylenediamine, 1,2- and 1,3-diaminopropane, 1,4-diaminobutane, 1,6-diaminohexane, isophorone-diamine, isomer mixture of 2,2,4- and 2,4,4-trimethyl-hexamethylene-diamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic acid dihydrazide. Also suitable for use are compounds which contain active hydrogen of different reactivity towards NCO groups, such as compounds which contain, in addition to a primary amino group, also secondary amino groups or, in addition to an amino group (primary or secondary), also OH groups. Examples thereof are primary/secondary amines, such as 3-amino-1-methyl-aminopropane, 3-amino-1-ethylaminopropane, 3-amino-1-cyclohexylaminopropane, 3-amino-1-methylaminobutane, also alkanolamines such as N-aminoethylethanol-amine, ethanolamine, 3-aminopropanol or neopentanolamine.

In certain embodiments, component (c) is used in an amount of at least 1% by weight, such as at least 3% or at least 5% by weight and no more than 10% by weight, such as no more than 8% or, in some cases, no more than 7% by weight, based on the total weight of reactants used to make the polyester based polyurethane dispersion.

Suitable solubilizing agents (d) in accordance with the invention are free of carboxylic acid groups, and include ionic solubilizing agents such as solubilizing agents that have an anionically hydrophilising action. Some examples of suitable amines for component (d) preferably contain a sulfonic acid or sulfonate group, and particularly preferably a sodium sulfonate group. Suitable anionically hydrophilising compounds as component (d) are preferably the alkali metal salts of mono- and diaminosulfonic acids. Examples of these anionic hydrophilising agents are salts of 2-(2-aminoethylamino)ethanesulfonic acid, ethylenediamine propyl- or -butylsulfonic acid, 1,2- or 1,3-propylenediamine-β-ethylsulfonic acid or taurine. In addition, the salt of cyclohexylaminopropanesulfonic acid (CAPS) from U.S. Pat. No. 6,767,958, the disclosure of which is herein incorporated by reference, can be used as an anionic hydrophilising agent.

Other suitable solubilizing agents include non-ionic solubilizing agents. Some examples of suitable non-ionic solubilizing agents for use herein as component (d) include, for example, a mono-functional polyalkylene ether that contains at least one, in some cases only one, hydroxy or amino group. In some embodiments, component (d) comprises compounds of the formula:

H—Y′—X—Y—R

in which R is a monovalent hydrocarbon radical having 1 to 12 carbon atoms, such as an unsubstituted alkyl radical having 1 to 4 carbon atoms; X is a polyalkylene oxide chain having 5 to 90, such as 20 to 70 chain members, which may comprise at least 40%, such as at least 65%, ethylene oxide units and which in addition to ethylene oxide units may comprise propylene oxide, butylene oxide and/or styrene oxide units; and Y and Y′ are each independently oxygen or —NR′— in which R′ is H or R, in which R is defined above.

Mono-functional polyalkylene ethers which are suitable for use as component (d) may, in some cases, contain 7 to 55 ethylene oxide units per molecule, and can be obtained by alkoxylation of suitable starter molecules, such as, for example, saturated monoalcohols, such as methanol, ethanol, n-propanol, isopropanol, n-butanol, isobutanol, secbutanol, the isomeric pentanols, hexanols, octanols and nonanols, n-decanol, n-dodecanol, n-tetradecanol, n-hexadecanol, n-octadecanol, cyclohexanol, the isomeric methyl-cyclohexanols or hydroxymethylcyclohexane, 3-ethyl-3-hydroxymethyloxetan or tetrahydrofurfuryl alcohol; diethylene glycol monoalkyl ethers, such as, for example, diethylene glycol monobutyl ether; unsaturated alcohols, such as allyl alcohol, 1,1-dimethylallyl alcohol or oleic alcohol; aromatic alcohols, such as phenol, the isomeric cresols or methoxyphenols; araliphatic alcohols, such as benzyl alcohol, anise alcohol or cinnamic alcohol; secondary monoamines, such as dimethylamine, diethylamine, dipropylamine, diisopropylamine, dibutylamine, bis-(2-ethylhexyl)-amine, N-methyl- and N-ethyl-cyclohexylamine or dicyclohexylamine; as well as heterocyclic secondary amines, such as morpholine, pyrrolidine, piperidine or 1H-pyrazole, including mixtures of two or more of any of the foregoing.

Alkylene oxides suitable for the alkoxylation reaction include, for example, ethylene oxide and propylene oxide, which can be used in the alkoxylation reaction in any desired sequence or alternatively in admixture. In some embodiments, component (d) comprises a copolymer of ethylene oxide with propylene oxide that contains ethylene oxide in an amount of at least 40% by weight, such as at least 50% by weight, at least 60% by weight or at least 65% by weight and/or up to 90% by weight or up to 80% by weight, based on the total weight of ethylene oxide and propylene oxide. In certain embodiments, the Mn of such a copolymer is 300 g/mol to 6000 g/mol, such as 500 g/mol to 4000 g/mol, such as 1000 g/mol to 3000 g/mol.

In certain embodiments, component (d) is used in an amount of at least 0.1% by weight, or at least 1% by weight, or at least 5%, or at least 10% by weight or no more than 30% by weight, such as no more than 20% by weight, based on the total weight of reactants used to make the polyurethane, with the proviso that these are both free of carboxylic acid groups.

Suitable surfactants (e) in accordance with the invention include any surfactants known to be suitable in polyurethane chemistry. Some examples of suitable surfactants include, for example, cationic surfactants, anionic surfactants, zwitterionic or non-ionic surfactants. Examples of anionic surfactants include sulfonates, and phosphates. Carboxylates are not generally considered suitable anionic surfactants in accordance with the invention. Examples of cationic surfactants include quaternary amines. Examples of non-ionic surfactants include block copolymers containing ethylene oxide and silicone surfactants. Also suitable are surfactants that are known to be useful in preparing a stable froth. These are commonly referred to as foam stabilizers and include, for example, sulfates, succinamates and sulfosuccinamates. Surfactants are typically used in an amount of from 0.1 to 10% by weight, based on the total weight of reactants used to make the polyester based polyurethane dispersion.

Water (f) is used in an amount of at least 20% by weight, such as at least 25%, or at least 30% by weight and/or no more than 65% by weight, such as no more than 50% by weight, based on the total weight of reactants used to make the polyester based polyurethane dispersion. Thus, the amount of water present may vary between any combination of these upper and lower limits, such as, for example, from at least 20% by weight to less than 65% by weight of water, or from at least 25% by weight to less than 50% by weight of water, or from at least 30% by weight to less than 50% by weight of water, based on the total weight of all reactants used to make the aqueous polyester based polyurethane dispersion.

The polyester polyurethane dispersion may optionally comprise a suitable catalyst (g). In accordance with the invention, suitable catalysts include, for example, any of the catalysts which are known to be suitable for use in polyurethane chemistry. Some examples include trimethylamine, stannous octoate, dibutyltin oxide, dibutyltin dilaurate and other conventional polyurethane catalysts.

In various embodiments, the aqueous polyurethane dispersion (PUD) contains (2) a polycarbodiimide dispersion in an amount of from 1% to 20% by weight, based on 100% by weight of (1) the aqueous polyester based polyurethane dispersion. Polycarbodiimides are polymers containing the group:

[symbol]

N═C═N

[symbol]

and may be formed by self-addition polymerization of a diisocyanate using organo-phosphorous compounds or by anionic polymerization of a carbodiimide. In some embodiments, the polycarbodiimides are aliphatic, in other embodiments, the polycarbodiimides are aromatic, in certain embodiments, the polycarbodiimides are a mixture of aliphatic and aromatic. Suitable polyisocyanates for polymerization into polycarbodiimide dispersions (2) for use in the present invention include, but are not limited to, N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

In various non-limiting embodiments, the polycarbodiimide dispersion (2) is included in amounts of from 1% to 20%, based on 100% by weight of (1) the aqueous polyester based polyurethane dispersion; in certain embodiments, polycarbodiimide dispersion (2) is preferably used in amounts of from 3% to 16%, more preferably in amounts of from 5% to 14%, based on 100% by weight of (1) the aqueous polyester based polyurethane dispersion. The polycarbodiimide dispersion (2) is preferably employed in the form of a dispersion, more preferably in the form of a waterborne dispersion. It has surprisingly been found that the inclusion of polycarbodiimide dispersion (2) in an aqueous polyurethane dispersion comprising a polyester based polyurethane dispersion containing a solubilizing component that is free of carboxylic acid groups stabilizes a number of performance properties, and also restores physical performance of an aqueous PUD after degradation of performance.

Any of a variety of processes can be used to prepare the aqueous polyurethane dispersion (PUD) of the present invention, such as the prepolymer mixing method, acetone method or melt dispersing method, each of which will be understood by a person skilled in the art of making aqueous polyurethane dispersions. For example, in some embodiments, the aqueous polyurethane dispersions of the present invention may be produced by the acetone method, such as is described, for example, in U.S. Patent Application Publication No. 2007/0167565 A1 at paragraphs [0057]-[0073], the cited portion of which being incorporated herein by reference.

In certain embodiments, the resin solids content of the aqueous polyurethane dispersion (PUD) prepared by any of these methods is at least 20% by weight, or at least 25%, or at least 30% by weight; and no more than 65% by weight, or no more than 60% by weight, based on the total weight of the dispersion.

The aqueous polyurethane dispersions (PUDs), coatings, adhesives, and sealants of the present invention may further include any of a variety of additives such as defoamers, devolatilizers, thickeners, flow control additives, colorants (including pigments and dyes), surfactants, dispersants, and neutralizers as is known to those skilled in the art.

The aqueous polyurethane dispersions (PUDs) and coatings of the present invention may be admixed and combined with the conventional paint-technology binders, auxiliaries and additives, selected from the group of pigments, dyes, matting agents, flow control additives, wetting additives, slip additives, pigments, including metallic effect pigments, fillers, nanoparticles, light stabilizing particles, anti-yellowing additives, thickeners, and additives for reducing the surface tension.

The aqueous polyurethane dispersions (PUDs), coatings, adhesives, according to the invention can be applied to the substrate by the conventional techniques, such as, spraying, rolling, flooding, printing, knife-coating, pouring, brushing and dipping.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated.

ISOCYANATE A: 4,4′-dicyclohexylmethane diisocyanate having an NCO group content of about 31.8% and a functionality of about 2
ISOCYANATE B: hexamethylene-1,6-diisocyanate having an NCO group content of about 49.7% and a functionality of about 2
POLYOL A: polyester of adipic acid, hexanediol and neopentyl glycol, OH number 66, Mₙ=1700 g mol
POLYOL B: a butyl-diglycol based PO/EO (15.6%/63.5%) monol capped with EO (20.9%) having a hydroxyl number of about 25 mg KOH/g
EXTENDER A: hydrazine hydrate, 100% (HyHy)
EXTENDER B: 2-methyl-1,5-pentanediamine, commercially available as DYTEK A from INVISTA
SOLUBILIZING AGENT A: sodium sulfonate-diol molecular weight weighted 432 g/mol
SURFACTANT A: a nonionic wetting agent and molecular defoamer (75% active liquid in ethylene glycol) commercially available from Air Products as SURFYNOL 104H
Co-Solvent A: butyl carbitol
Leveling Agent A: a solution of a polyether modified siloxane, BYK 346
Polycarbodiimide Dispersion A: a waterborne dispersion of a hydrophilically modified aliphatic polycarbodiimide, 40% by weight resin solids in water

Table 1 provides the formulation of PUD-A (Polyester Polyurethane Dispersion A) used in the working examples. Polyester Polyurethane Dispersion A was made by charging the specified amounts of the relevant isocyanates, solubilizing agent and catalyst to a reaction vessel and heating the vessel at 60° C. The specified amounts of polyols were added to the vessel and the mixture was stirred at 85° C. to just below the theoretical NCO value. The resultant prepolymer was dispersed in the specified amount of water along with the specified amount of surfactant. Extenders were added dropwise and the mixture was mixed for one hour while cooling to room temperature. The polyester polyurethane dispersion was filtered before use.

TABLE 1
POLYESTER POLYURETHANE DISPERSION A

| Component | Weight percent |
|---|---|
| ISOCYANATE A | 7.5% |
| ISOCYANATE B | 2.1% |
| SOLUBILIZING | 3.8% |
| AGENT A | |
| POLYOL A | 24.6% |
| POLYOL B | 1.9% |
| EXTENDER A | 0.2% |
| EXTENDER B | 1.5% |
| WATER | 58.1% |
| SURFACTANT A | 0.3% |

Polyester polyurethane dispersion A was from Table 1 was used to prepare Paint Formulation I as shown in Table 2. First, the specified amounts of PUD-A, Co-Solvent A and Leveling Agent A were charged to a vessel, and then the specified amount of Polycarbodiimide Dispersion A was added, followed by mixing.

TABLE 2
PAINT FORMULATION I

| | Percent of carbodiimide (%) | | |
|---|---|---|---|
| | 0% | 5% | 15.7% |
| Component 1 | | | |
| PUD-A (pbw) | 99.01 | 94.04 | 85.47 |
| Co-solvent A | 0.66 | 0.94 | 0.85 |
| (pbw) | | | |
| Leveling Agent A | 0.33 | 0.31 | 0.28 |
| (pbw) | | | |
| Component 2 | | | |
| Polycarbodiimide | 0 | 4.7 | 13.39 |
| Dispersion A | | | |
| (pbw) | | | |
| TOTAL (pbw) | 100.0 | 99.9 | 99.9 |

TABLE 2A
MEK DOUBLE RUB RESISTANCE
OF PAINT FORMULATION I

| | Period after | | Amount of | |
|---|---|---|---|---|
| | Manufacture of | | polycarbodiimide | MEK double-rub |
| EXAMPLE | PUD-A* | | dispersion | resistance |
| 1A | 3 | months | 0% | 175 |
| 1B | 3 | months | 5% | 200 |
| 1C | 3 | months | 15.7% | 225 |
| 2A | 6 | months | 0% | 100 |
| 2B | 6 | months | 5% | 250 |
| 2C | 6 | months | 15.7% | 100 |
| 3A | 9 | months | 0% | 75 |
| 3B | 9 | months | 5% | 200 |
| 3C | 9 | months | 15.7% | 100 |
| 4A | 1.5 | years | 0% | 100 |
| 4B | 1.5 | years | 5% | 175 |
| 4C | 1.5 | years | 15.7% | 100 |

*stored at ambient temperature

TABLE 2B
MEK DOUBLE-RUB RESISTANCE
OF PAINT FORMULATION I

| EXAMPLE | 5 | 6 | 7 |
|---|---|---|---|
| Amount of | 0% | 5% | 15.7% |
| Polycarbodiimide | | | |
| Dispersion | | | |
| Initial | 45 | 110 | 95 |
| After 2 weeks at | 25 | 80 | 90 |
| 50° C. | | | |

In TABLE 2A, PUD-A was aged at ambient temperature for different periods (e.g. 3 months, 6 months, 9 months and 1.5 years). Storage of a polyester polyurethane dispersion typically decreases the performance of the dispersion over time. See the MEK double rub resistance of Example 1A and compare this with the MEK double rub resistance of Example 2A, 3A and/or 4A in TABLE 2A. At the end of each time period in TABLE 2A, the aged PUD-A was used to form a paint formulation prepared according to Table 2 to evaluate restoration of performance as measured by MEK double rub resistance after the performance of PUD-A degraded during storage. Compare the MEK double rub resistance of Examples 1B and 1C with Example 1A; Examples 2B and 2C with Example 2A; Examples 3B and 3C with Example 3A; and Examples 4B and 4C with Example 4A.

In addition, to evaluate stability of mixture of PUD-A and Polycarbodiimide Dispersion A, the paints shown in TABLE 2B were tested. The paint in each Example was tested initially, and tested again after being stored at 50° C. for 2 weeks. This allows one to comp are the MEK double rub resistance performance after 2 weeks storage at 50° C. to the initial performance of the mixture after preparation. The use of the phrase “initial performance” here refers to the resistance or stability of the mixture of PUD-A and Polycarbodiimide Dispersion A against MEK double rubs immediately after the mixture is formed. Films were made from each formulation for testing. The film thickness was 4 mils (wet) and the films were initially dried at 90t for 20 minutes and left at 50t for 3 days to cure completely.

MEK double-rub resistance was done according to ASTM D 5402. The rubs are counted as a double rub and measured until breakthrough of the film.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicants reserve the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. An aqueous polyurethane dispersion (PUD) comprising the reaction product of: (1) a polyester polyurethane dispersion comprising (a) a polyester polyol; (b) a di- and/or polyisocyanate; (c) a chain extender containing at least two amine groups; (d) a solubilizing agent that is free of carboxylic acid groups; (e) a surfactant, (f) water, and, optionally, (g) a catalyst; and (2) from 1 to 20% by weight, based on 100% by weight of (1) the aqueous polyester based polyurethane dispersion, of a polycarbodiimide dispersion.

Clause 2. The aqueous polyurethane dispersion (PUD) according to Clause 1, wherein (1)(a) the polyester polyol has a molecular weight of from 400 to 8000 g/mol and a functionality of 1.5 to 6.

Clause 3. The aqueous polyurethane dispersion (PUD) according to one of Clauses 1 and 2, wherein (1)(a) the polyester polyol comprises the condensation product of at least one diol, triol or tetraol with at least one dicarboxylic acid, tricarboxylic acid, tetracarboxylic acid, hydroxycarboxylic acid, an anhydride or a lactone.

Clause 4. The aqueous polyurethane dispersion (PUD) according to one of Clauses 1 to 3, wherein (1)(a) the polyester polyol comprises the reaction product of at least one of butanediol, neopentyl glycol and hexanediol, with at least one of adipic acid and phthalic acid.

Clause 5. The aqueous polyurethane dispersion (PUD) according to one of Clauses 1 to 4, wherein (1)(c) the chain extender comprises at least one of hydrazine hydrate and 2-methyl-1,5-pentanediamine.

Clause 6. The aqueous polyurethane dispersion (PUD) according to one of Clauses 1 to 5, wherein (1)(c) the chain extender is present in an amount of at least 1% by weight to no more than 10% by weight, based on 100% by weight of (1).

Clause 7. The aqueous polyurethane dispersion (PUD) according to one of Clauses 1 to 6, wherein (1)(d) the solubilizing agent comprises a compound comprising a sodium sulfonate group.

Clause 8. The aqueous polyurethane dispersion (PUD) according to one of Clauses 1 to 7, wherein (1)(e) the surfactant is present in an amount of least 0.1% to no more than 10% by weight, based on 100% by weight of (1).

Clause 9. The aqueous polyurethane dispersion (PUD) according to one of Clauses 1 to 8, wherein (1)(e) the surfactant is free of carboxylic acid groups.

Clause 10. The aqueous dispersion (PUD) according to one of Clauses 1 to 9, wherein said polycarbodiimide dispersion comprises at least one of N,N′-dicyclohexylcarbodiimide, N,N′-diisopropylcarbodiimide, 1-ethyl-3-(3-dimethylaminopropyl)carbodiimide and 1-cyclohexyl-(2-morpholinoethyl)carbodiimide metho-p-toluenesulfonate.

Clause 11. The aqueous polyurethane dispersion according to one of claims 1 to 10, wherein (2) said polycarbodiimide dispersion is present in an amount of from 3% to 16% by weight, based on the weight of (1).

Clause 12. An aqueous polyurethane dispersion according to one of Clauses 1 to 11, which exhibits improved resistance to degradation as measured by the MEK double rub resistance test in accordance with ASTM D-5402.

Clause 13. An aqueous polyurethane dispersion according to one of Clauses 1 to 12, in which the performance of the dispersion as measured by the MEK double rub resistance test in accordance with ASTM D 5402 improves after storage for at least 3 months.

Clause 14. A process for preparing an aqueous polyurethane dispersion (PUD) comprising (A) reacting (1) a polyester polyurethane dispersion comprising (a) a polyester polyol component, (b) a di- or polyisocyanate component, (c) a chain extender containing at least two amine groups; (d) a solubilizing component that is free of carboxylic acid groups, (e) a surfactant, (f) water, and, optionally, (g) a catalyst; and (2) from 1 to 20% by weight, based on 100% by weight of (1) the aqueous polyester based polyurethane dispersion, of a polycarbodiimide dispersion.

Clause 15. The process according to Clause 14, wherein (1)(a) the polyester polyol has a molecular weight of from 400 to 8000 g/mol and a functionality of 1.5 to 6.

Clause 16. The process according to one of Clauses 14 or 15, wherein (1)(a) the polyester polyol comprises the condensation product of at least one diol, triol or tetraol with at least one dicarboxylic acid, tricarboxylic acid, tetracarboxylic acid, hydroxycarboxylic acid, an anhydride or a lactone.

Clause 17. The process according to one of Clauses 14 to 16, wherein (1)(a) the polyester polyol comprises the reaction product of at least one of butanediol, neopentyl glycol and hexanediol, with at least one of adipic acid and phthalic acid.

Clause 18. The process according to one of Clauses 14 to 17, wherein (1)(c) the chain extender comprises at least one of hydrazine hydrate and 2-methyl-1,5-pentanediamine.

Clause 19. The process according to one of Clauses 14 to 18, wherein (1)(c) the chain extender is present in an amount of at least 1% to no more than 10% by weight, based on 100% by weight of (1).

Clause 20. The process according to one of Clauses 14 to 19, wherein (1)(d) the solubilizing agent comprises a compound comprising a sodium sulfonate group.

Clause 21. The process according to one of Clauses 14 to 20, wherein (1)(e) the surfactant is present in an amount of at least 0.1% to no more than 10% by weight, based on 100% by weight of (1).

Clause 22. The process according to one of Clauses 14 to 21, wherein (1)(e) the surfactant is free of carboxylic acid groups.

Clause 23. The process according to one of Clauses 14 to 22, wherein (2) the polycarbodiimide dispersion comprises at least one of N,N′-dicyclohexylcarbodiimide, N,N′-diisopropylcarbodiimide, 1-ethyl-3-(3-dimethylaminopropyl)carbodiimide and 1-cyclohexyl-(2-morpholinoethyl)carbodiimide metho-p-toluenesulfonate.

Clause 24. The process according to one of Clauses 14 to 23, wherein (2) said polycarbodiimide dispersion is present in an amount of from 3% to 16% by weight, based on the weight of (1).

Clause 25. The process according to one of Clauses 14 to 24, which exhibits improved resistance to degradation as measured by the MEK double rub test in accordance with ASMT D 5402.

Clause 26. The process according to one of Clauses 14 to 25, in which the performance of the dispersion as measured by the MEK double rub resistance test in accordance with ASTM D 5402 improves after storage for at least 3 months.

What is claimed is:

1. An aqueous polyurethane dispersion (PUD) comprising:
(1) a polyester polyurethane dispersion comprising:
(a) a polyester polyol component;
(b) a di- or polyisocyanate component;
(c) a chain extender containing at least two amine groups;
(d) a solubilizing component that is free of carboxylic acid groups;
(e) a surfactant;
(f) water;
and, optionally,
(g) a catalyst;
and
(2) from 1 to 20% by weight, based on 100% by weight of (1) the aqueous polyester based polyurethane dispersion, of a polycarbodiimide dispersion.

2. The aqueous polyurethane dispersion of claim 1, wherein (1)(a) said polyester polyol has a molecular weight of from 400 to 8000 g/mol and a functionality of 1.5 to 6.

3. The aqueous polyurethane dispersion of claim 1, wherein (1)(a) said polyester polyol comprises the condensation product of at least one diol, triol or tetraol with at least one dicarboxylic acid, tricarboxylic acid, tetracarboxylic acid, hydroxycarboxylic acid, an anhydride, or a lactone.

4. The aqueous polyurethane dispersion of claim 1, wherein (1)(a) said polyester polyol comprises the reaction product of at least one of butanediol, neopentyl glycol, and hexanediol, with at least one of adipic acid and phthalic acid.

5. The aqueous polyurethane dispersion of claim 1, wherein (1)(c) said chain extender comprises at least one of hydrazine hydrate and 2-methyl-1,5-pentanediamine.

6. The aqueous polyurethane dispersion of claim 1, wherein (1)(c) said chain extender is present in an amount of at least 1% to no more than 10% by weight, based on 100% by weight of (1).

7. The aqueous polyurethane dispersion of claim 1, wherein (1)(d) said solubilizing agent comprises a compound comprising a sodium sulfonate group.

8. The aqueous polyurethane dispersion of claim 1, wherein (1)(e) said surfactant is present in an amount of at least 0.1% to no more than 10% by weight, based on 100% by weight of (1).

9. The aqueous polyurethane dispersion of claim 1, wherein (1)(e) said surfactant is free of carboxylic acid groups.

10. The aqueous polyurethane dispersion of claim 1, wherein (2) said polycarbodiimide dispersion comprises at least one of N,N′-dicyclohexylcarbodiimide, N,N′-diisopropylcarbodiimide, 1-ethyl-3-(3-dimethylaminopropyl)carbodiimide, and 1-cyclohexyl-(2-morpholinoethyl)carbodiimide metho-p-toluenesulfonate.

11. The aqueous polyurethane dispersion of claim 1, wherein (2) said polycarbodiimide dispersion is present in an amount of from 3 to 16% by weight, based on 100% by weight of (1).

12. The aqueous polyurethane dispersion of claim 1, which exhibits improved resistance to degradation as measured by the MEK double rub resistance test in accordance with ASTM D 5402.

13. The aqueous polyurethane dispersion of claim 1, in which the performance of the dispersion as measured by the MEK double rub resistance test in accordance with ASTM D 5402 improves after storage for at least 3 months.

14. A process for preparing an aqueous polyurethane dispersion (PUD) comprising
(A) reacting:
(1) a polyester polyurethane dispersion comprising:
(a) a polyester polyol component;
(b) a di- or polyisocyanate component;
(c) a chain extender containing at least two amine groups;
(d) a solubilizing component that is free of carboxylic acid groups;
(e) a surfactant;
(f) water;
and, optionally,
(g) a catalyst;
and
(2) 1 to 20% by weight, based on 100% by weight of (1) the aqueous polyester based polyurethane dispersion, of a polycarbodiimide dispersion.

15. The process according to claim 14, wherein (1)(a) said polyester polyol has a molecular weight of from 400 to 8000 g/mol and a functionality of 1.5 to 6.

16. The process according to claim 14, wherein (1)(a) said polyester polyol comprises the condensation product of at least one diol, triol or tetraol with at least one dicarboxylic acid, tricarboxylic acid, tetracarboxylic acid, hydroxycarboxylic acid, an anhydride, or a lactone.

17. The process according to claim 14, wherein (1)(a) said polyester polyol comprises the reaction product of at least one of butanediol, neopentyl glycol, and hexanediol, with at least one of adipic acid and phthalic acid.

18. The process according to claim 14, wherein (1)(c) said chain extender comprises at least one of hydrazine hydrate and 2-methyl-1,5-pentanediamine.

19. The process according to claim 14, wherein (1)(c) said chain extender is present in an amount of at least 1% to no more than 10% by weight, based on 100% by weight of (1).

20. The process according to claim 14, wherein (1)(d) said solubilizing agent comprises a compound comprising a sodium sulfonate group.

21. The process according to claim 14, wherein (1)(e) said surfactant is present in an amount of at least 0.1% by weight to no more than 10% by weight, based on 100% by weight of (1).

22. The process according to claim 14, wherein (1)(e) said surfactant is free of carboxylic acid groups.

23. The process according to claim 14, wherein (2) said polycarbodiimide dispersion comprises at least one of N,N′-dicyclohexylcarbodiimide, N,N′-diisopropylcarbodiimide, 1-ethyl-3-(3-dimethylaminopropyl)carbodiimide, and 1-cyclohexyl-(2-morpholinoethyl)carbodiimide metho-p-toluenesulfonate.

24. The process according to claim 14, wherein (2) said polycarbodiimide dispersion is present in an amount of from 3 to 16% by weight, based on 100% by weight of (1).

25. The process according to claim 14, which exhibits improved resistance to degradation as measured by the MEK double rub resistance test in accordance with ASTM D 5402.

26. The process according to claim 14, in which the performance of the dispersion as measured by the MEK double rub resistance test in accordance with ASTM D 5402 improves after storage for at least 3 months.
